(19) United States
(12) Patent Application Publication
(10) Pub. No.: US 2025/0130432 A1
(43) Pub. Date: Apr. 24, 2025

(54) PROJECTOR SPACING AS A FUNCTION OF LENS SPACING ON A WAFER

(71) Applicant: Google LLC, Mountain View, CA (US)

(72) Inventors: Daniel Adema, Kitchener (CA); Shreyas Potnis, Kitchener (CA)

(21) Appl. No.: 18/921,164

(22) Filed: Oct. 21, 2024

Related U.S. Application Data
(60) Provisional application No. 63/591,866, filed on Oct. 20, 2023.

(51) Int. Cl. G02B 27/01

(52) U.S. Cl. CPC G02B 27/0179; G02B 27/0172; G02B 2027/0178

(57) ABSTRACT

According to an aspect, a method includes identifying a lens pitch associated with a wafer. The method further includes determining a projector pitch for a first projector and a second projector on the wafer based on the lens pitch. The method also includes selecting a portion of the wafer for a device based on the projector pitch.

### CROSS-REFERENCE TO RELATED APPLICATION

This application claims priority to U.S. Provisional Patent Application No. 63/591,866, filed on Oct. 20, 2023, entitled “PROJECTOR SPACING AS A FUNCTION OF WAFER OPTICS SPACING,” the disclosure of which is incorporated by reference herein in its entirety.

### BACKGROUND

Extended Reality (XR) displays, which include virtual reality (VR), augmented reality (AR), and mixed reality (MR) devices, work by creating immersive or augmented environments through high-resolution screens or projections. These displays can use Organic Light Emitting Diode (OLED), Micro Light Emitting Diode (microLED), Liquid Crystal Display (LCD), or another display technology housed inside headsets or smart glasses to project images directly into the user's field of view. In VR, the display fully immerses the user in a digital environment by covering the visual field with three-dimensional content. In AR, the display overlays digital information onto the physical world through transparent or semi-transparent lenses. XR displays rely on sensors like cameras, gyroscopes, and accelerometers to track head movement, adjust the view dynamically, and provide a seamless, interactive experience.

### SUMMARY

This disclosure relates to systems and methods for determining a projector pitch based on a lens pitch on a wafer. In at least one implementation, a wafer includes an array of lenses or lenslets with a configured pitch. A lenslet is a small, individual lens, included as part of an array, used to focus or direct light in optical systems for applications like display technologies. Lenslet pitch refers to the distance between the centers of adjacent lenslets in the array. Based on the lenslet pitch, a system can be configured to determine a projector pitch associated with a first projector and a second projector for a binocular display system. In at least one implementation, the projector pitch refers to the distance between adjacent projection elements, such as the right projection element for the user's right eye and the left projection element for the user's right eye. In at least one implementation, the determined projection pitch represents an integer multiple of the lenslet pitch. Once the projector pitch is determined, the system can select or dice the wafer based on the projector pitch.

In some aspects, the techniques described herein relate to a method including: identifying a lens pitch associated with a wafer; determining a projector pitch for a first projector and a second projector on the wafer based on the lens pitch; and selecting a portion of the wafer for a device based on the projector pitch.

In some aspects, the techniques described herein relate to an apparatus including: a computer-readable storage medium; and program instructions stored on the computer-readable storage medium that, when executed by at least one processor, direct the at least one processor to perform a method, the method including: identifying a lens pitch associated with a wafer; determining a projector pitch for a first projector and a second projector on the wafer based on the lens pitch; and selecting a portion of the wafer for a device based on the projector pitch.

In some aspects, the techniques described herein relate to a system including: a first set of one or more lenses on a wafer; and a second set of one or more lenses on the wafer, wherein a projector pitch defines a distance between the first set of one or more lenses and the second set of one or more lenses, and wherein the projector pitch includes an integer multiple of a lens pitch for the wafer.

The accompanying drawings and the description below set forth the details of one or more implementations. Other features will be apparent from the description, drawings, and claims.

### BRIEF DESCRIPTION OF THE DRAWINGS

FIG. 1 illustrates an extended reality (XR) computing device according to an implementation.

FIG. 2 illustrates an operational scenario of selecting a projector pitch for a binocular display system according to an implementation.

FIG. 3 illustrates an operational scenario of selecting a projector pitch for a binocular display system according to an implementation.

FIG. 4 illustrates a method of selecting projector pitch for a binocular display system according to an implementation.

FIG. 5 illustrates a computing system to select projector pitch for a binocular display according to an implementation.

### DETAILED DESCRIPTION

This disclosure relates to systems and methods for selecting projector pitch (or spacing) for a binocular display system as a function of lens pitch on a wafer. A binocular display system in an XR device, such as a VR or AR headset, is designed to present two slightly different images, one for each eye, to create a stereoscopic three-dimensional effect. This system replicates how human eyes perceive depth by taking advantage of binocular vision, where each eye views the world from a slightly different angle. In an XR device, the images displayed to each eye are calculated to mimic this disparity, making the virtual or augmented environment appear three-dimensional and lifelike. The system can use high-resolution OLEDs or LCDs combined with lenses that help focus and converge the light from the display screens into the correct position for the user's eyes.

In some implementations, the optics required for the binocular display system are generated using wafer level optics (WLO). WLO refers to fabricating optical components, such as lenses and lens arrays, directly on a semiconductor wafer using techniques like those used in semiconductor manufacturing. This approach allows for producing precise, miniaturized optical elements, making it cost-effective for applications in mobile and XR devices. WLO can enable the integration of multiple optical components into a single package, improving performance and reducing the size of devices. However, at least one technical problem with WLO is aligning the right and left projectors as part of a binocular display system.

In at least one technical solution, a wafer includes lenses that can be referred to as lenslets. A lenslet is a small lens, typically part of a lenslet array, fabricated directly on a semiconductor wafer using wafer-level optics technology. In XR devices, such as AR or VR headsets, these lenslets are used to manipulate light precisely for image formation, improving visual clarity and field of view. In some implementations, a first set of one or more lenslets is used to provide projection associated with the display for the right eye, and a second set of one or more lenslets is used to provide projection associated with the display for the right eye. As part of at least one technical solution, lenses (or lenslets) from the same wafer can be selected or diced for both projectors. As a technical effect, using lenses from the same wafer simplifies aligning the projections for the left and right eye.

In some implementations, a computing system can be configured to identify the lens pitch to select the lens for the projectors. Lens pitch refers to the distance between the centers of adjacent lenses in the array. Based on the lens pitch, a system can be configured to determine a projector pitch associated with a first projector and a second projector for the binocular display system. In at least one implementation, the projector pitch refers to the distance between adjacent projection elements, such as the right projection element for the user's right eye and the left projection element for the user's right eye. In at least one implementation, the determined projection pitch represents an integer multiple of the lens pitch. Once the projector pitch is determined, the system can select or dice the wafer based on the projector pitch. The selection or dicing is used to cut the wafer into a size and shape for a device, such as an XR or another head-mounted device.

In some implementations, the computing system can be configured to consider other factors when selecting the diced shape from the wafer. In some examples, the computing system can identify the quantity of lenses required for each projector. The computing system can then determine the diced shape of the wafer to accommodate the quantity of lenses and the projector pitch. In some examples, the computing system can be configured to determine the arrangement of the lenses for each projector. Based on the arrangement and the determined projector pitch, the computing system can be configured to select the diced shape of the wafer. In a further example, the computing system can be configured to determine the device type or the distance from a left eye lens (or screen) to a right eye lens (or screen). Based on the distance and the projector pitch, the computing system can determine the diced shape of the wafer. In some implementations, any combination of the factors above can be used in addition to the projector pitch to select the diced shape of the wafer.

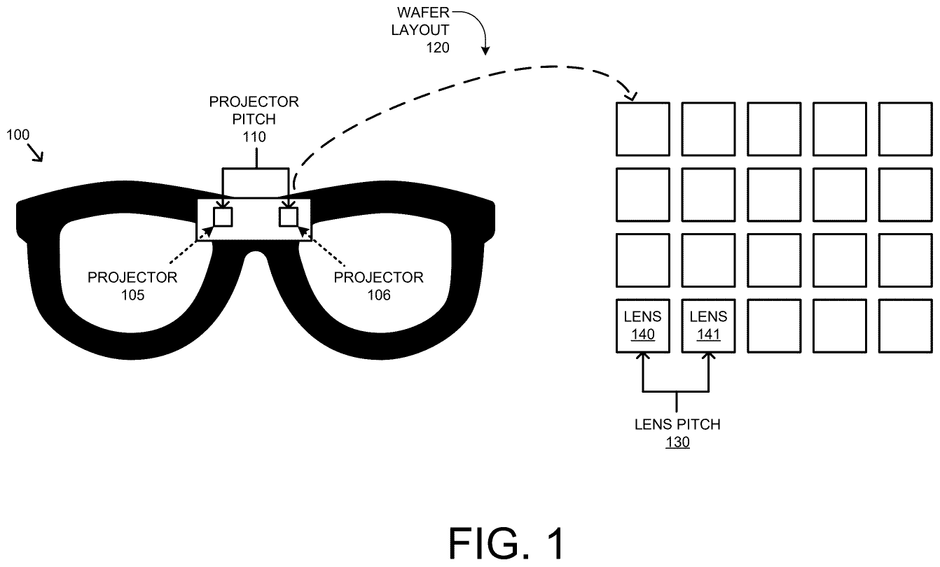

FIG. 1 illustrates an XR computing device 100 according to an implementation. XR computing device 100 includes projector 105, projector 106, projector pitch 110, wafer layout 120, lens 140, lens 141, and lens pitch 130.

XR computing device 100 can include hardware components designed to enable immersive experiences. The hardware can include lenses or screens, often placed directly in front of the user's eyes in VR headsets or as transparent lenses in AR and MR devices. These displays can be coupled with sensors, such as accelerometers, gyroscopes, and magnetometers, which track head and body movements, allowing the device to adjust the virtual content accordingly. Cameras and depth sensors can also be used, especially in AR and MR devices, to capture the surrounding environment and integrate virtual objects into the real world. XR devices can also be configured with built-in speakers or spatial audio systems to provide immersive soundscapes.

Additionally, XR devices can include processors and graphic processing units (GPUs) to handle the real-time rendering of complex virtual environments and interactive elements. These processors enable the device to track user inputs, process visual and spatial data, and update the virtual content. Handheld controllers or hand-tracking sensors can be used for input, allowing users to interact with digital objects through natural movements. Some devices can also incorporate eye-tracking sensors to enhance precision and provide more intuitive control.

For XR computing device 100, XR computing device 100 includes projector 105 and projector 106. Projector 105 and projector 106 create a binocular display by projecting two slightly different images for each eye onto the lenses or screens of XR computing device 100. This mimics how human eyes perceive depth by receiving slightly different perspectives of the same scene. This stereoscopic effect enables depth perception, enhancing the sense of immersion in virtual or augmented environments. The hardware that supports projector 105 and projector 106 includes WLO. WLO refers to fabricating optical components, such as lenses and lens arrays, directly on a semiconductor wafer using techniques like those used in semiconductor manufacturing. This approach allows for producing precise, miniaturized optical elements, making it cost-effective for applications in mobile and XR devices. WLO can enable the integration of multiple optical components into a single package.

For XR computing device 100, a diced or selected portion of a WLO wafer supports both projector 105 and projector 106. Wafer layout 120 is representative of a WLO wafer. It includes at least lens 140 and lens 141 with a lens pitch of 130. Lens pitch 130 refers to the distance between the centers of adjacent lenses fabricated in an array on a single wafer. It determines the spacing of the lenses and influences the alignment, optical performance, and overall functionality of the system. To improve the process of aligning the right and left projectors for a device, such as XR computing device 100, the right and left projectors (i.e., projectors 105-106) can be diced or selected from the same wafer. Projector 105 and projector 106 are separated by projector pitch 110. Projector pitch refers to the distance between the projection points of the two projectors, one for each eye, which is important for creating stereoscopic vision and depth perception. In some implementations, the pitch is aligned to match the user's interpupillary distance (IPD) to ensure that each eye receives the correct image, allowing for a comfortable and realistic three-dimensional viewing experience.

In some examples, a computing system can be configured to select a shape for dicing projector 105 and projector 106 from a single wafer. Wafer dicing is the process of cutting a semiconductor wafer into individual dies or chips, typically using a saw or laser. In determining the diced shape or portion cut from the wafer, the system can evaluate projector pitch 110 based at least on the lens pitch 130. Projector pitch 110 represents an integer multiple of lens pitch 130 in at least one implementation. For example, lens pitch 130 can represent one unit, and projector pitch 110 can represent an integer multiple of the unit. This can permit the cutting or dicing of the projectors from a single wafer based on the established lens pitch. As at least one technical effect, by cutting or dicing both projectors for a binocular display system from the same wafer, the alignment configuration for the end device can more easily be determined.

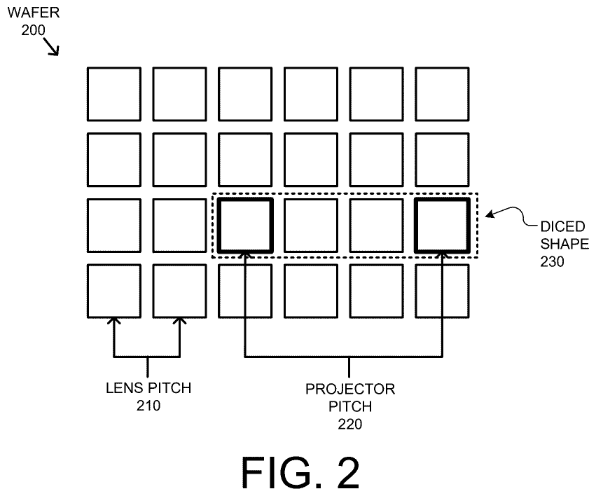

FIG. 2 illustrates an operational scenario of selecting a projector pitch for a binocular display system according to an implementation. The operational scenario includes Wafer 200 with lens pitch 210, projector pitch 220, and diced shape 230.

In FIG. 2, a computing system, which can include one or more computers, identifies a lens pitch 210 for wafer 200. Lens pitch 210 refers to the center-to-center distance between adjacent microlenses on a wafer. It is a critical parameter that impacts the optical performance and alignment in imaging systems, as well as the overall integration density of the lens array. From lens pitch 210, the system determines a projector pitch 220 for a first projector and a second projector on the wafer based on the lens pitch. Projector pitch refers to the physical separation or distance between the two projectors or image sources that present images as part of a binocular display. In some implementations, projector pitch 220 comprises an integer multiple of lens pitch 210. In some implementations, the projector pitch can further be determined based on one or more additional factors. The additional factors can include the display requirements for the end device with the binocular display, the number of lenses required for each projector, the arrangement of the lenses for each projector, or some other factor. For example, the computing system can further determine projector pitch 220 based on a display distance from the left and right display as part of an XR device. The integer multiple can then be selected based, at least in part, on the display distance. Advantageously, the computing system can change the projector pitch based on the application for the binocular display (e.g., a first type of XR device and a second type of XR device).

After projector pitch 220 is determined, the computing system further selects a portion of the wafer for a device based on the projector pitch. In the example, of wafer 200, diced shape 230 includes two lenses for the device, where each of the projectors includes a single lens. In some examples, additional lenses can be used by each of the projectors with varying arrangements and quantities of lenses. In some implementations, diced shape 230 can be determined based on the quantity of lenses required for each projector, the arrangement of the lenses required for each projector, the requirements of the end device (e.g., distance between left and right screens), or based on some other factor. Once diced shape 230 is selected, the shape can be cut from wafer 200. Dicing wafer 200 refers to the process of cutting a wafer containing multiple optical components, like lenses or sensors, into individual units. This is done using precision cutting tools, such as lasers or diamond blades, to separate each optical clement without damaging the delicate structures.

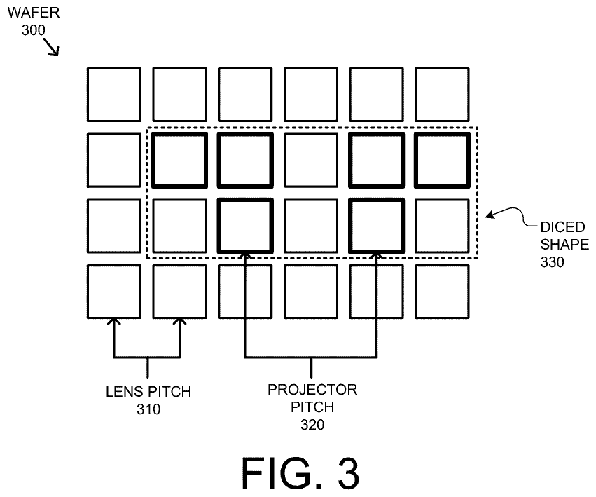

FIG. 3 illustrates an operational scenario of selecting a projector pitch for a binocular display system according to an implementation. The operational scenario includes wafer 300 with lens pitch 310, projector pitch 320, and diced shape 330.

In FIG. 3, a computing system, which can include one or more computers, identifies a lens pitch 310 for wafer 300. Lens pitch 310 refers to the center-to-center distance between adjacent microlenses on a wafer. It is a critical parameter that impacts the optical performance and alignment in imaging systems, as well as the overall integration density of the lens array. From lens pitch 310, the system determines a projector pitch 320 for a first projector and a second projector on the wafer based on the lens pitch. In some implementations, projector pitch 320 comprises an integer multiple of lens pitch 310. In some implementations the projector pitch can further be determined based on one or more additional factors. The additional factors can include the display requirements for the end device with the binocular display, the quantity of lenses required for each projector, the arrangement of the lenses for each projector, or some other factor. For example, the computing system can further determine projector pitch 320 based on a display distance from the left and right display as part of an XR device. The integer multiple can then be selected based, at least in part, on the display distance. Advantageously, the computing system can change the projector pitch based on the application for the binocular display.

As another example, the computing system can determine the quantity and orientation of the lenses required for each projector. The quantity and orientation can be used in conjunction with lens pitch 310 to determine the projector pitch 320. The projector pitch can be referred to as the separation or distance between the optical centers of the two projectors. The optical center of a projector can be the point where the projector's lens axis intersects with the image plane, representing the center of the projected image's light path.

Here, projector pitch 320 is defined based on the distance between the projectors, and diced shape 330 is selected to incorporate the required lenses for each projector. Specifically, diced shape 330 combines three lenses for each right and left projector. The factors associated with selecting diced shape 330 can include projector pitch 320, the number of lenses for each of the projectors, the arrangement of the lenses for each projector, the device type, or some other factor. Diced shape 330 is selected to ensure that the lenses associated with the projectors are selected while limiting waste associated with the wafer. As at least one technical effect, the remaining portions of wafer 300 can be used in association with binocular systems for other devices.

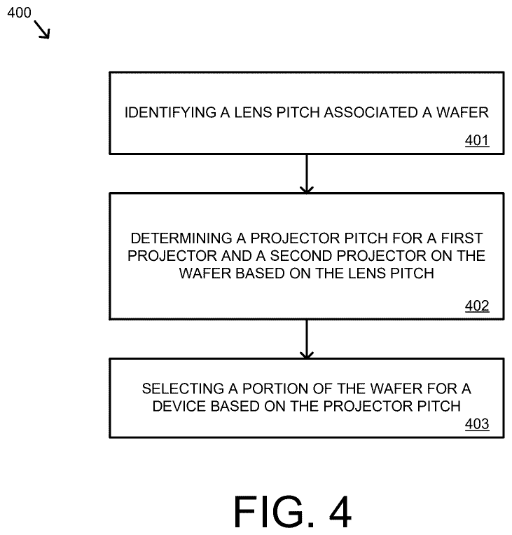

FIG. 4 illustrates method 400 of selecting projector pitch for a binocular display system according to an implementation. The steps of method 400 are referenced parenthetically in the paragraphs that follow.

Method 400 includes identifying (401) a lens pitch associated with a wafer. Lens pitch refers to the center-to-center distance between adjacent lenslets or microlenses (i.e., lenses) in an array on the wafer. It determines the packing density and uniformity of the lenses, which can be used for configuring binocular display systems. In some implementations, the lens pitch can be provided by an administrator. In some implementations, at least one sensor or other device can measure the lens pitch.

Method 400 further includes determining (402) a projector pitch for a first projector and a second projector on the wafer based on the lens pitch. Projector pitch can refer to the distance or separation between the optical centers of the two projectors. In some examples, this distance can match the viewer's IPD. In some implementations, projector pitch comprises an integer multiple of the lens pitch. The technical effect permits a left-eye projector and the right-eye projector to be diced from the same wafer, improving the alignment process associated with the right-eye projector and the left-eye projector. The improvement occurs as the projectors share the same wafer, permitting the lenses to be aligned on the same wafer.

In some implementations, the projector pitch can further be determined based on one or more additional factors. In at least one example, the system can determine the distance between the left-eye display and the right-eye display on the end device (e.g., lenses of an XR device). The distance can be used in conjunction with the lens pitch to calculate the projector pitch. In at least one example, the quantity or arrangement of the lenses can be considered when determining the projector pitch. The quantity or arrangement can be used to determine the optical centers for each of the projectors. Thus, when combined with the lens pitch, a projector pitch can be determined, representing an integer multiple of the lens pitch. Additional factors can also be considered when determining the projector pitch and can be combined with any of the aforementioned factors.

Method 400 further includes selecting (403) a portion of the wafer for a device based on the projector pitch. The selected portion of the wafer includes the lenses for both the right and left projectors. In some implementations, the selection can factor in the number of lenses for each projector, the arrangement of the lenses for each projector, fit requirements associated with the end device (e.g., XR device), or some other factor. Once selected, the wafer can be diced to cut the corresponding lenses and other electronics from the wafer. Dicing a WLO wafer can involve cutting or slicing the wafer into individual optical components, such as the projectors for the binocular display system. This process can use techniques like laser cutting or mechanical sawing to ensure minimal damage to the delicate optical structures.

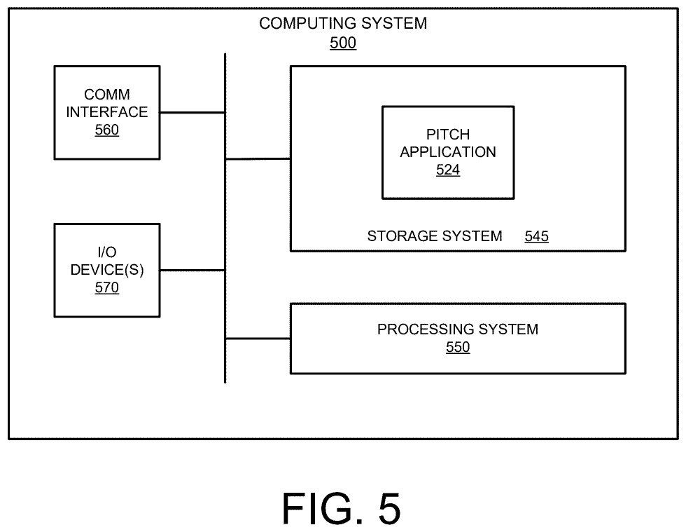

FIG. 5 illustrates a computing system 500 to select projector pitch for a binocular display according to an implementation. Computing system 500 can represent any computing system or systems with which the various operational architectures, processes, scenarios, and sequences disclosed herein for selecting a projector pitch may be implemented. computing system 500 includes storage system 545, processing system 550, communication interface 560, input/output (I/O) device(s) 570. Processing system 550 is operatively linked to communication interface 560, I/O device(s) 570, and storage system 545. In some implementations, communication interface 560 and/or I/O device(s) 570 may be communicatively linked to storage system 545. Computing system 500 may further include other components, such as a battery and enclosure, that are not shown for clarity.

Communication interface 560 comprises components that communicate over communication links, such as network cards, ports, radio frequency, processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format-including combinations thereof. Communication interface 560 may be configured to communicate with external devices, such as servers, user devices, or other computing devices.

I/O device(s) 570 may include computer peripherals that facilitate the interaction between the user and computing system 500. Examples of I/O device(s) 570 may include keyboards, mice, trackpads, monitors, displays, printers, cameras, microphones, external storage devices, and the like.

Processing system 550 comprises microprocessor circuitry (e.g., at least one processor) and other circuitry that retrieves and executes operating software (i.e., program instructions) from storage system 545. Storage system 545 may include volatile and nonvolatile, removable, and non-removable media implemented in any method or technology for information storage, such as computer-readable instructions, data structures, program modules, or other data. Storage system 545 may be implemented as a single storage device and across multiple storage devices or sub-systems. Storage system 545 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises pitch application 524. The operating software on storage system 545 may further include an operating system, utilities, drivers, network interfaces, applications, or some other type of software. When read and executed by processing system 550 the operating software on storage system 545 directs computing system 500 to operate as a computing device as described herein. The operating software can provide at least method 400 of FIG. 4 in at least one implementation.

In at least one example, pitch application 524 directs processing system 550 to a lens pitch associated with a wafer. Pitch application 524 further directs processing system 550 to determine a projector pitch for a first projector and a second projector on the wafer based on the lens pitch. Pitch application 524 further directs processing system 550 to select a portion of the wafer for a device based on the projector pitch.

In some implementations, the determination of the projector pitch and the selection of the portion of the wafer can include additional factors. The additional factors can include the device type (or desired distance between the left and right screen for a user), the number of lenses for each projector, the arrangement of the lenses for each projector, or some other factor.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing aspects and is not intended to be limiting. On the contrary, this patent covers all methods, apparatus and articles of manufacture fairly falling within the scope of the claims of this patent.

What is claimed is:

1. A method comprising;
identifying a lens pitch associated with a wafer;
determining a projector pitch for a first projector and a second projector on the wafer based on the lens pitch; and
selecting a portion of the wafer for a device based on the projector pitch.

2. The method of claim 1, wherein the projector pitch comprises an integer multiple of the lens pitch.

3. The method of claim 1, wherein the device comprises an extended reality device, and wherein the first projector and the second projector provide a binocular display.

4. The method of claim 1 further comprising:
determining a first quantity of lenses for the first projector; and
determining a second quantity of lenses for the second projector;
wherein selecting the portion of the wafer for the device based on the projector pitch is further based on the first quantity of lenses and the second quantity of lenses.

5. The method of claim 1 further comprising:
determining a first arrangement of at least one lens for the first projector; and
determining a second arrangement of at least one lens for the second projector;
wherein selecting the portion of the wafer for the device based on the projector pitch is further based on the first arrangement and the second arrangement.

6. The method of claim 1 further comprising:
determining a distance from a left eye display and a right eye display on the device;
wherein selecting the portion of the wafer for the device based on the projector pitch is further based on the distance from the left eye display and the right eye display on the device.

7. The method of claim 1, wherein the first projector comprises a first set of one or more lenses, and wherein the second projector comprises a second set of one or more lenses.

8. An apparatus comprising:
a computer-readable storage medium; and
program instructions stored on the computer-readable storage medium that, when executed by at least one processor, direct the at least one processor to perform a method, the method comprising:
identifying a lens pitch associated with a wafer;
determining a projector pitch for a first projector and a second projector on the wafer based on the lens pitch; and
selecting a portion of the wafer for a device based on the projector pitch.

9. The apparatus of claim 8, wherein the projector pitch comprises an integer multiple of the lens pitch.

10. The apparatus of claim 8, wherein the device comprises an extended reality device, and wherein the first projector and the second projector provide a binocular display.

11. The apparatus of claim 8, wherein the method further comprises:
determining a first quantity of lenses for the first projector; and
determining a second quantity of lenses for the second projector;
wherein selecting the portion of the wafer for the device based on the projector pitch is further based on the first quantity of lenses and the second quantity of lenses.

12. The apparatus of claim 8, wherein the method further comprises:
determining a first arrangement of at least one lens for the first projector; and
determining a second arrangement of at least one lens for the second projector;
wherein selecting the portion of the wafer for the device based on the projector pitch is further based on the first arrangement and the second arrangement.

13. The apparatus of claim 8, wherein the method further comprises:
determining a distance from a left eye display and a right eye display on the device;
wherein selecting the portion of the wafer for the device based on the projector pitch is further based on the distance from the left eye display and the right eye display on the device.

14. The apparatus of claim 8, wherein the first projector comprises a first set of one or more lenses, and wherein the second projector comprises a second set of one or more lenses.

15. The apparatus of claim 8 further comprising the at least one processor.

16. A system comprising:
a first set of one or more lenses on a wafer; and
a second set of one or more lenses on the wafer, wherein a projector pitch defines a distance between the first set of one or more lenses and the second set of one or more lenses, and wherein the projector pitch comprises an integer multiple of a lens pitch for the wafer.

17. The system of claim 16, wherein the first set of one or more lenses correspond to a left eye in a binocular display.

18. The system of claim 16, wherein the second set of one or more lenses correspond to a second eye in a binocular display.

19. The system of claim 16, wherein the wafer is mounted to an extended reality device.

20. The system of claim 19, wherein the projector pitch is defined at least in part by a distance between a left eye lens and a right eye lens on the extended reality device.
